(19) United States
(12) Patent Application Publication
(10) Pub. No.: US 2014/0108972 A1
(43) Pub. Date: Apr. 17, 2014

(54) RECONFIGURABLE SELF-SERVICE KIOSK

(71) Applicant: NASCENT TECHNOLOGY, LLC, Chalotte, NC (US)

(72) Inventors: Fabio Teti, Waxhaw, NC (US); Scott Christopher Urban, Charlotte, NC (US); Joshua Daniel Jackson, Charlotte, NC (US); Jeffrey Robert Necciai, Matthews, NC (US)

(73) Assignee: NASCENT TECHNOLOGY, LLC, Chalotte, NC (US)

(21) Appl. No.: 14/053,873

(22) Filed: Oct. 15, 2013

Related U.S. Application Data
(60) Provisional application No. 61/713,750, filed on Oct. 15, 2012.

(51) Int. Cl. G06F 3/0484

(52) U.S. Cl. CPC G06F 3/0484
USPC 715/762

(57) ABSTRACT

A kiosk system including an interface, at least one peripheral device, and a processor communicatively coupled to the interface and the at least one peripheral device, the processor configured to create interactive content, publish the interactive content to the interface, and execute the interactive content published to the interface. A non-transitory medium for executing processes associated with a reconfigurable kiosk including at least one peripheral device, which when executed by a processor, causes the processor to perform operations.

### CROSS-REFERENCE TO RELATED APPLICATION

This application claims priority to U.S. 61/713,750 filed Oct. 15, 2012, the contents of which are incorporated by reference herein.

### TECHNICAL FIELD AND BACKGROUND OF THE INVENTION

The present invention relates generally to the field of kiosks and other self-service terminals, and more particularly, to a reconfigurable kiosk including a hardware interface configured to readily connect various compatible peripheral devices, and a software application configured to create, change and reconfigure applications executed on the interface.

Self-service kiosks and like terminals are known for providing repetitive services such as gathering information, disseminating information, completing transactions, etc. Kiosks are typically custom-built based on the services/transactions provided, and thus require custom housings, peripherals, and programming. Such a level of customization makes it difficult and costly to reconfigure the housing, add or remove peripherals, integrate new peripherals into the programming, reprogram applications, etc. as the need arises. Further, hardware and programming changes require action on the part of the kiosk supplier, thereby increasing costs, dependency on another, and system downtime.

Accordingly, to overcome the disadvantages of prior art systems, provided herein is a fully integrated, reconfigurable kiosk solution that includes a hardware front end and software backend that work together to allow the service provider to set-up and reconfigure self-service terminals and applications as needed. Such a system provides a universal kiosk solution.

### BRIEF SUMMARY OF THE INVENTION

In one aspect, provided herein is a reconfigurable kiosk system and methods that support a reconfigurable kiosk.

In another aspect, provided herein are systems and methods for creating customized kiosk applications.

In yet another aspect, provided herein is a reconfigurable kiosk including an interface communicatively coupled with one or more peripheral devices.

To achieve the foregoing and other aspects and advantages, provided herein is a reconfigurable kiosk system including an interface, at least one peripheral device, and a processor communicatively coupled to the interface and the at least one peripheral device, the processor configured to create interactive content, publish the interactive content to the interface, and execute the interactive content published to the interface.

In a further embodiment, the at least one peripheral device may include one or more of an information reader, an information writer, a camera, an audio device, a communications device, a scanner, and a biometrics device.

In a further embodiment, the interface may be a touch-responsive display.

In a further embodiment, the interface may include non-volatile data storage, an embedded operating system, and the processing unit.

In a further embodiment, the interface may be a unitary, Ethernet-based, input/output controllable, audio and video streaming device.

In a further embodiment, the interface may include an audio controller configured to support multiple audio streaming protocols, speaker outputs, an external microphone input, and a dedicated telephone handset connection.

In a further embodiment, the audio controller may include a plurality of dedicated outputs, a plurality of dedicated inputs, and form-C relays.

In a further embodiment, the interface may include at least one of a built-in camera, an RS232 DB9 serial port, an RS422/485 configurable port with 4-wire support, a USB connection, and a VGA connection for a monitor.

In a further embodiment, the kiosk may include an enclosure for housing the interface and the at least one peripheral device.

In another embodiment, provided herein is a non-transitory medium for executing processes associated with a reconfigurable kiosk including at least one peripheral device, which when executed by a processor, causes the processor to perform operations including creating interactive content, publishing the interactive content to an interface communicatively coupled to the processor, executing the interactive content published to the interface, and communicating with the at least one peripheral device.

In a further embodiment, the interactive content may be a packaged file including a collection of forms to be displayed on the interface and containing instructions to be executed by the interface.

In a further embodiment, each form may include an object representation of encapsulated functionality for performing at least one of a peripheral device-specific function and presenting information visually.

In a further embodiment, triggers instructing the processor to carry out actions may be associated with peripheral device functions and are conveyed to the processor along with data from the at least one peripheral device.

In a further embodiment, the processor may be configured to carry out actions in response to triggers associated with the peripheral device functions, wherein actions comprise one or more of loading forms, transitioning to other forms, displaying messages, copying values of text fields, and executing a web service call.

In a further embodiment, assets comprising images, logos, preconfigured assets, and added assets may be stored in an asset library and are available to be added to the forms.

In a further embodiment, the processor may be configured to execute the interactive content on the interface, render the forms, collect data from the interface and the at least one peripheral device, and execute instructions.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the present invention are better understood when the following detailed description of the invention is read with reference to the accompanying drawings, in which:

FIGS. 1a-c illustrate various terminal housings including a variety of peripheral devices;

FIG. 2 is a block diagram illustrating system functionality;

FIG. 3 is a block diagram illustrating interface functionality;

FIG. 4 illustrates an exemplary component class hierarchy of the application;

FIG. 5 illustrates an exemplary interaction of Components, Triggers and Actions of the application;

FIG. 6 is a table listing Properties, Triggers and Actions associated with an example Form Component;

FIG. 7 is a table listing Properties and Actions associated with an example Label Component;

FIG. 8 is a table listing Properties, Triggers and Actions associated with an example TextInput Component;

FIG. 9 is a table listing Properties, Triggers and Actions associated with an example Command Button Component;

FIG. 10 illustrates an example FormSet file structure;

FIGS. 11a-f are tables listing exemplary Pseudo Class summary descriptions;

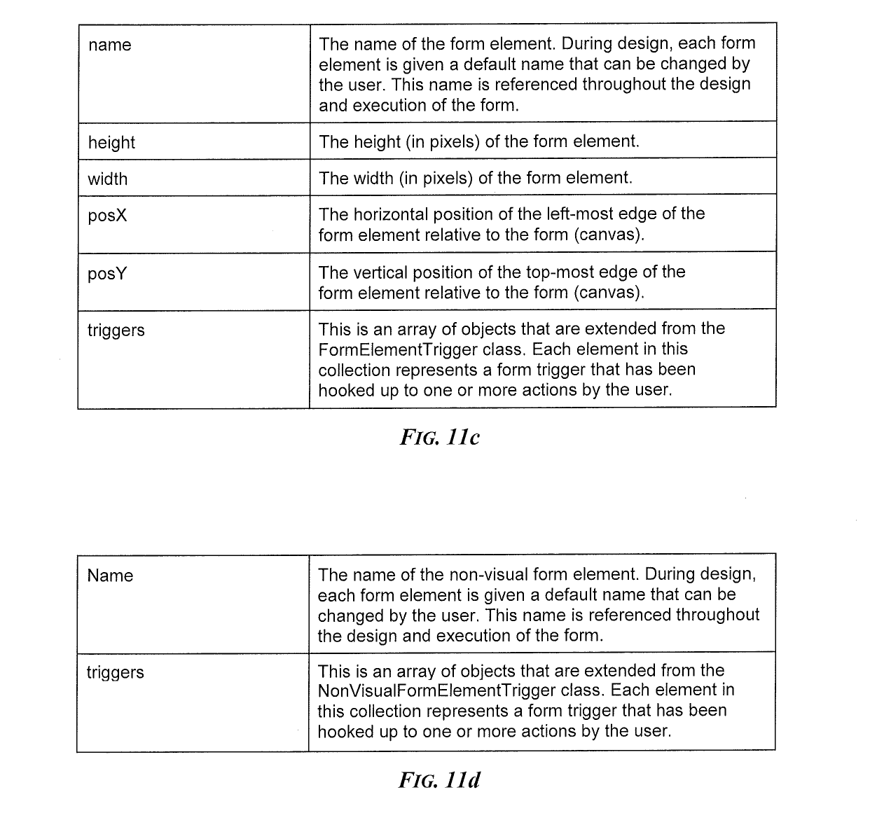

FIG. 12 is a table listing examples of pre-defined configuration settings; and

FIG. 13 is a table listing examples of supported Asset file types.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Disclosed herein are systems and methods for providing reconfigurable kiosk architecture. As used herein, the term “kiosk” is intended to generally describe a terminal or other device through which a user interfaces with a service provider created application for gathering/presenting data to the user. Examples of kiosks include enclosures, tablet computers, smart phones, etc. “Terminal” may also be used interchangeably herein with the term “interface,” as an interface may be a stand-alone terminal such as a tablet computer, or may be integrated into an enclosure such as a kiosk housing. As used herein, “service provider” is intended to denote the purchaser of a kiosk system and designer of the forms published to the interface, “user” is intended to denote the user of the interface, and “kiosk supplier” is intended to denote the manufacturer and/or supplier of the kiosk system.

The kiosk system generally includes integrated hardware and design software that allows a service provider to develop a self-service kiosk solution to fit their individual needs. The hardware interface can be configured by the service provider to allow users to perform any number of possible transactions using a variety of compatible peripheral devices. The system is modular, in that the enclosure and interface are configured to readily add/remove various hardware peripheral devices. Peripheral devices can include any number and type of input and/or output devices. Examples of input/output devices include, but are not limited to, touch responsive displays, information readers (e.g., scanner, card reader), information writers (e.g., printer), dispensers, cameras, biometric devices, keyboards, sensors, lights, audio input/output devices (e.g., microphone, speaker), communications devices (e.g., telephone, video conferencing equipment), etc.

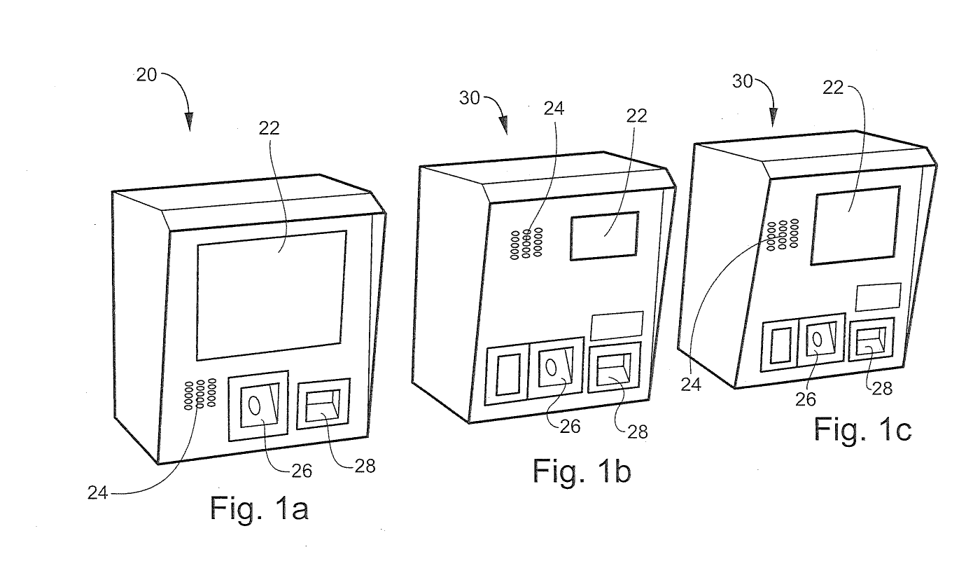

Referring to FIGS. 1a-c, exemplary embodiments of kiosk enclosures are shown including various peripheral devices in different arrangements. FIG. 1a illustrates an exemplary kiosk at reference numeral 20 generally including a large touch-responsive interface 22, keypad 24, biometrics device 26, and information writer 28. FIG. 1b illustrates another exemplary kiosk at reference numeral 30 generally including a smaller interface 22, keypad 24, biometrics device 26, and information writer 28. FIG. 1c illustrates a variation of kiosk 30 shown in FIG. 1b, in which the same peripheral devices are included, however, in a different arrangement and with a larger interface 22. In the exemplary kiosk embodiments, the enclosure 32 is a metal housing including a faceplate 34 that can be populated with various peripherals in various configurations. In this arrangement, peripherals can be readily interchanged by mounting such peripheral devices to the faceplate for presentation to the user. Durability and sealing performance of the enclosures may be enhanced or relaxed based upon the installation environment and intended use of the kiosk. The examples shown in FIGS. 1a-c illustrate only a few embodiments of kiosks terminals that can be reconfigured with various peripherals, and are not intended to be limiting examples.

The application portion of the system allows a service provider to create custom, effective, and comprehensive applications on their own without action on the part of the kiosk supplier. The system is generally configured to allow non-technical users the ability to create, and manage interactive applications used to disseminate and collect data from users. The system is primarily a “closed,” self-contained system containing pre-programmed “hooks” that allow collected data to be shared with external systems and, to an extent, allows the content and programming of the application to be dynamically controlled. The system allows the creation, manipulation and management of interactive applications to be accomplished through the interface. The system generally includes two major components: (1) the design center application, referred to herein as “the application”; and (2) the “interface”, both of which are described in detail below. The interface may be a visual display or non-visual display, depending on the application requirements and hardware functionality. As shown in FIGS. 1a-c, the interface 22 is a touch-responsive display.

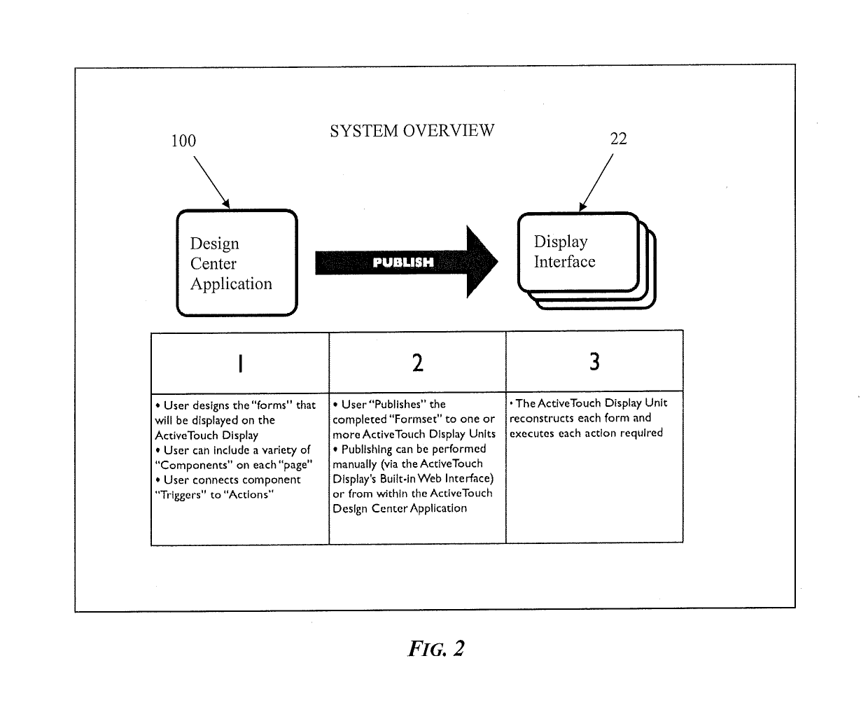

The basic system architecture is shown in FIG. 2. The application 100 is the backend software application operable for creating interactive content published and executed on the interface 22, or on multiple interfaces in an interface network. The primary output of the application 100 is a packaged file, referred to herein as a “FormSet,” which is a collection of “Forms” that contain instructions to be followed by the interface 22. Each interface 22 can include touchscreen functionality for ease of use, and is configured to render the content and follow instructions as specified in the FormSets.

The application 100 presents an intuitive interface through which the service provider designs content based upon specific needs. The application 100 includes a selection of commonly used “Components” for designing content and specifying “Actions.” Graphics and media can be added to the content. The application 100 preferably includes drag, drop and resize functionality for incorporating various interface objects on Forms, contains dialog and property panes for specifying “Actions” that take place when the FormSet is being “executed” on the display interface 12, and allows the ability to control aspects of the displayed forms such as colors, font, size, etc., among other functions. FormSets can be saved and recalled later for use and editing. The application 100 preferably runs on Microsoft Windows, Apple and Linux hardware, among others.

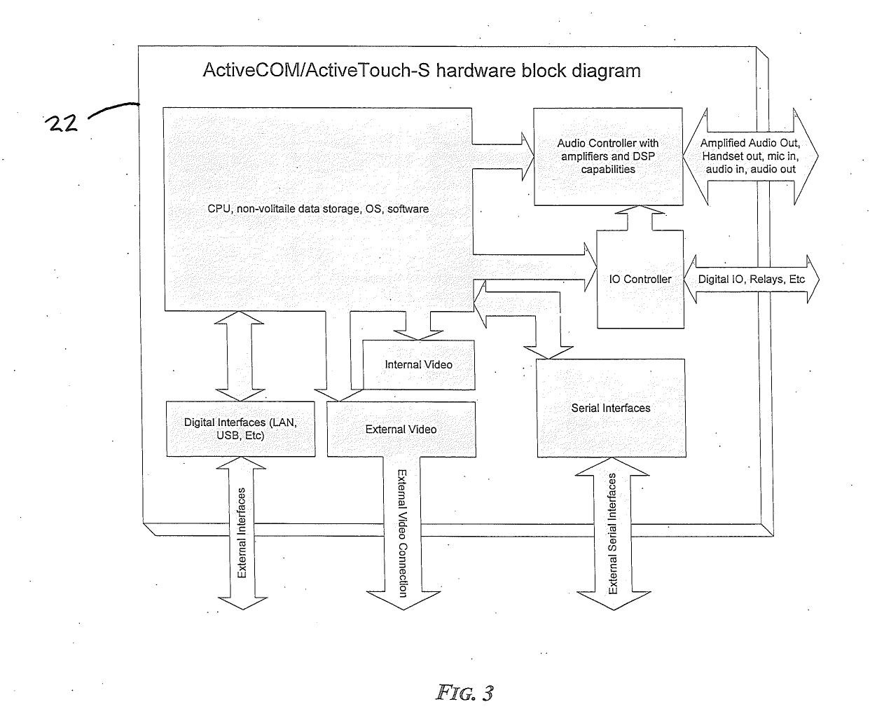

The functionality and general layout of the interface 22 is schematically represented in FIG. 3. The interface 22 is a computer generally including a processor, non-volatile data storage and embedded operating system for reproducing FormSet content and carrying out “Actions” included in a FormSet. The interface 22 is preferably a unitary Ethernet-based, IO control, audio and video streaming device. The audio controller preferably supports multiple audio streaming protocols, and physically supports speaker outputs, an external microphone input, and a dedicated telephone handset connection. Audio 10 control may be embedded, obviating the need for a separate IO controller to switch audio outputs.

The IO controller portion includes, in one example, 10 dedicated outputs (open collector), 10 dedicated inputs (30VDC capable), and 4 form-C relays (3 terminal). +5VDC and +12VDC output lines can be used to power low-power devices in close proximity, benefiting a power over Ethernet situation. The interface 22 may further include a built-in camera for providing streaming video to connected clients, an RS232 DB9 serial port, RS422/485 configurable port with 4-wire support, 4×USB support for external devices, VGA for an additional monitor, etc. The interface 22 is preferably compactly arranged in a single device configured for plug-and-play interconnection of compatible peripherals.

The interface 22 supports and accommodates various types of “hooks” utilized by the service provider for communicating with existing back-office and third-party systems. Separate Application Programming Interfaces (APIs) support communication through CGI, XML Web Services, and Socket Messages, among others, to forward collected data, query other services to perform “next steps,” display dynamic content to the user, etc. The interface 22 preferably contains a web-based interface to accommodate basic configuration and management and offer the ability to publish FormSets via file upload.

The application 100 generally operates to control the presentation and data collection activities on the interface 22. The application 100 can include a main navigation page including a “standard” main menu and associated toolbar. Exemplary menu structure can include basic functionality such as ‘New” for creating a new FormSet, ‘Open’ for opening an existing FormSet, ‘Close’ for closing the currently open FormSet, ‘Save’ for saving the current FormSet, ‘Save As’ for saving the current FormSet with a new name, ‘Publish’ for publishing the current FormSet to one or more interfaces 22, and ‘Exit’ for exiting the application. Functionality may include edit functions such as ‘Undo’ for context-sensitive undo functionality, ‘Cut’ for context-sensitive cut functionality, ‘Copy’ for context-sensitive copy functionality, ‘Paste’ for context-sensitive paste functionality, and ‘Select All’ for context-sensitive select all functionality.

The main window of the application 100 can include one or panels, each panel providing access to specific resources during the creation of a FormSet. The main window may be resizable to utilize maximum available screen size offered by the host computer. Exemplary work areas or panels within the main window can include a ‘Forms Panel’ for showing all of the created forms within the FormSet. Each form in this area may be represented by a thumbnail image reflecting the current design of the form. A ‘Canvas Panel’ may serve as the work area and represents the current form. This panel is where components are placed, resized, and arranged to design a form. A ‘Components Panel’ may contain graphical representations of various components that may be used on a form. A component may be “dragged” from this area onto the form for placement. Alternatively, the component may be double-clicked to place an instance of it on the current form. A ‘Properties Panel’ may display a list of “properties” for the current component. An ‘Assets Panel’ shows a listing of all three assets that have been added to the FormSet. In addition, this panel may contain ‘Add,’ ‘Remove,’ and ‘Rename’ buttons that will allow maintenance to the assets within the list. A ‘Non-Visuals Panel’ may show a listing of all of the non-visual components that have been added to the current form. The entries within this list may serve as the singular representation of the component. As such, components may be selected from this list to access properties and assign actions.

“Components,” “Triggers,” and “Actions” as used herein represent what the service provider can see and do within the system. The application 100 is the visual framework by which the client “hooks” Components, Triggers and Actions together in varying combinations.

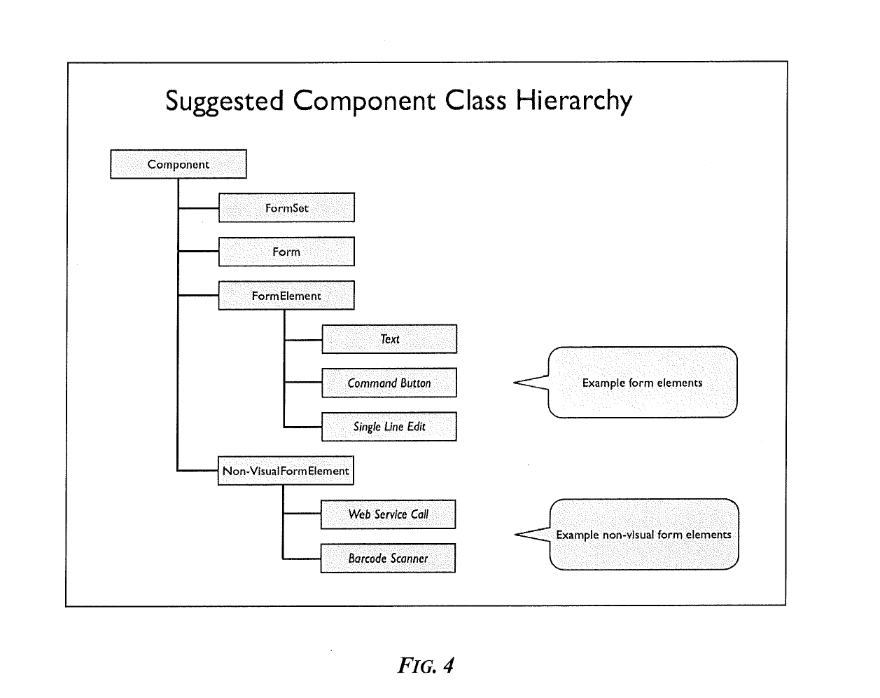

A “Component” as used herein refers to an object representation of encapsulated functionality for performing a specific task or presenting information visually. Thus, Components are the building blocks for designing a FormSet. An exemplary Component class hierarchy including FormSets, Forms, form elements, etc, is shown in FIG. 4. Components may be simple or may encapsulate complex tasks. For example, to display text on a Form may require a Label Component. The client may drag the Label onto the Form and set its properties, such as a value property, which may be the text to display. Visual Components may be classified as simple components, while Components that encapsulate device-specific functionality may be classified as complex. Components can be designed to carry out tasks related to hardware devices, for example, scanning a barcode, utilizing a biometrics reader, etc. Components can be non-visual, meaning they do not render anything visual on the finished form. Rather, they serve as an object representation of functionality. Components can be associated with a specific set of “Triggers” and a specific set of “Actions.”

A “Trigger” as used herein refers to something that happens with respect to a Component, such as an “event” in the programming. A Command Button Component, for example, may have a Clicked Trigger to indicate that a button was “pressed.” Triggers may or may not have data associated with them. Triggers with associated data have related information that is conveyed. For example, a Barcode Scanner Component may have a Scanned Trigger that occurs when a barcode is scanned, and the barcode data is carried along with the Trigger. Triggers are component specific, meaning that each Trigger is a part of a specific Component.

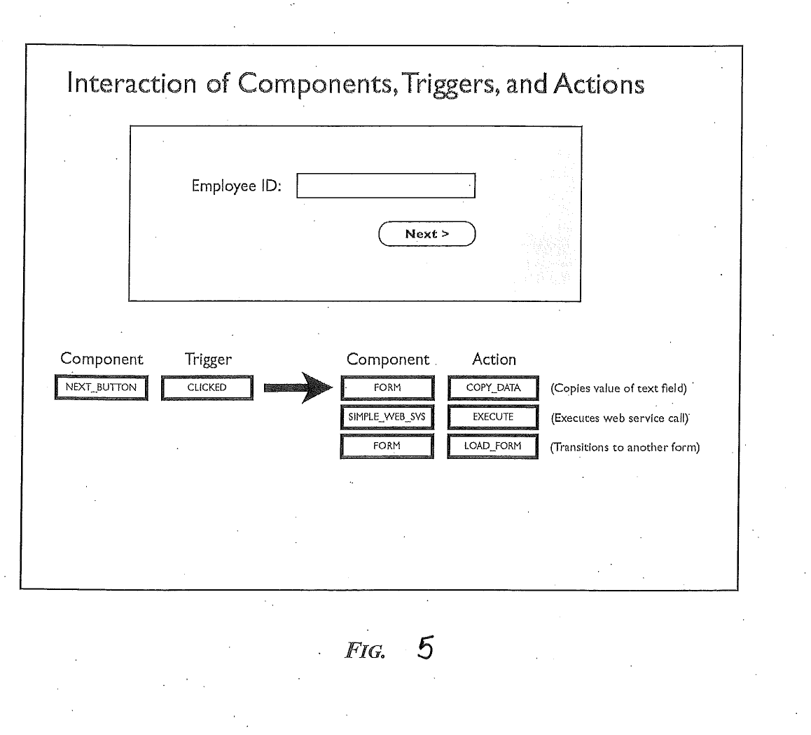

An “Action” as used herein refers to instructions carried out in response to Triggers. When designing a FormSet, for example, a service provider can hook one or more actions to be carried out in response to a Trigger. Like Components, Actions may range from simple to complex. Actions may or may not require data. Some Actions return data after being executed, while other Actions may not have a result. Like Triggers, Actions are Component-specific. In the application 100, a Component's Trigger can be hooked to another Component's Action. Referring to FIG. 5, one example of the interaction of Components, Triggers and Actions is shown.

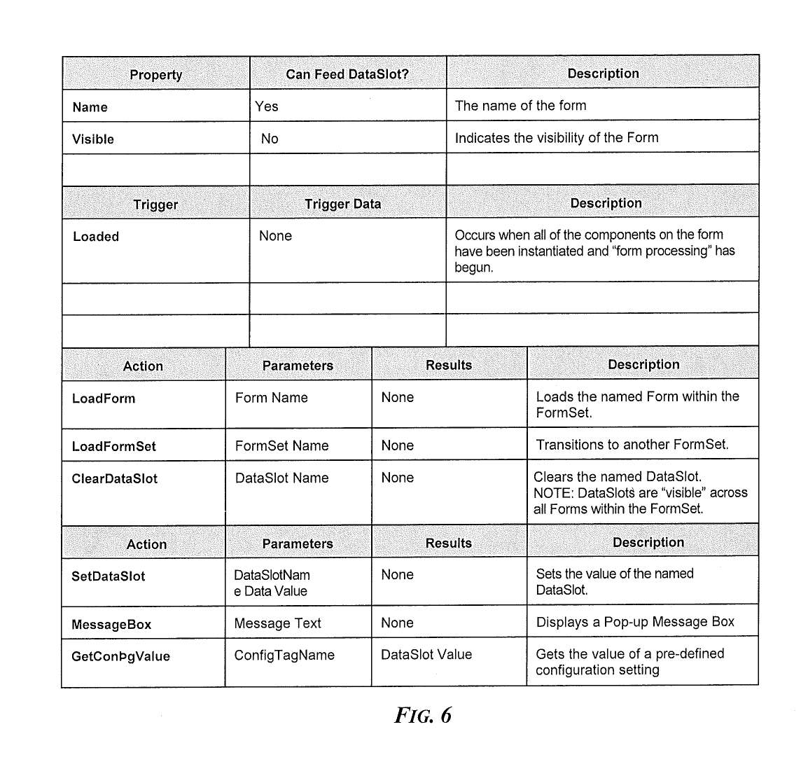

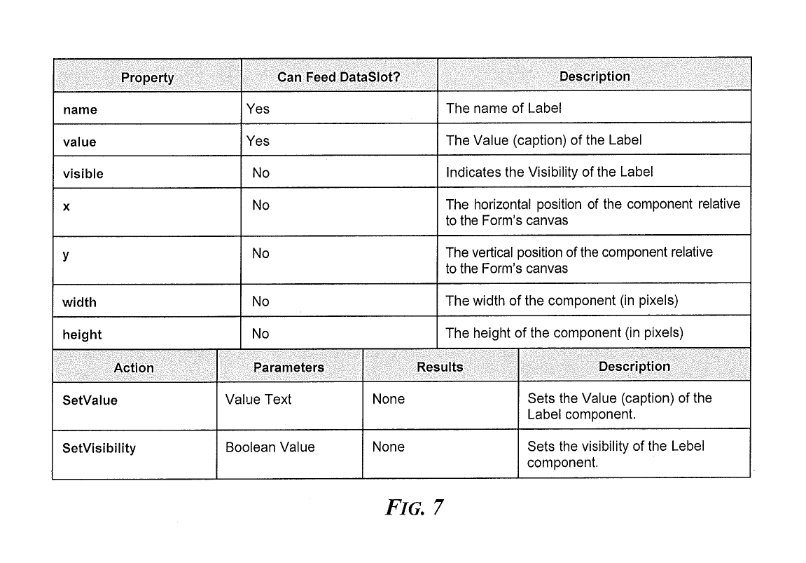

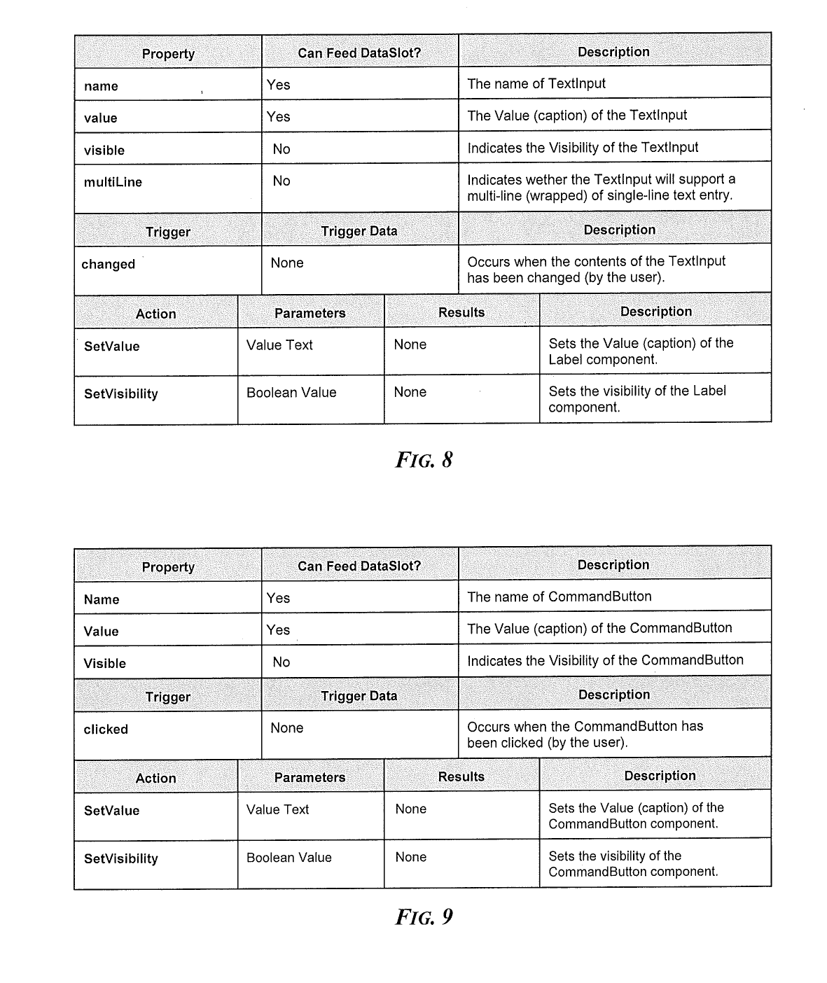

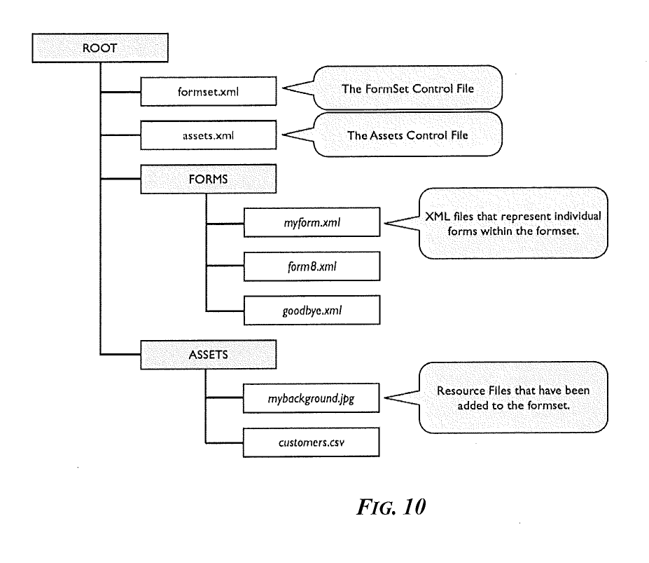

One example of a Component can be a Form Component, which represents a single canvas (either visible or non-visible) within a FormSet. The Form serves as the “container” for other visual as well as non-visual components. A FormSet can include any number of Forms. Each Form can be referred to using an assigned name, such as a name assigned by the service provider. FIG. 6 lists Properties, Triggers and Actions associated with a Form. FIG. 7 lists Properties and Actions associated with an example Label Component. FIG. 8 lists Properties, Triggers and Actions associated with an example TextInput Component. The TextInput Component allows a service provider of the FormSet to enter text. FIG. 9 lists Properties, Triggers and Actions associated with an example Command Button Component.

Portions of exemplary XML-documents for storing data for a FormSet Control file, Assets Control file and the form of the application 100 are shown below, and are intended to represent exemplary high-level data structures.

The FormSet Control File

```
<FormSet>
        LAST NAME</Name>
  <Name>GENERAL_EXAMPLE</Name>
  <StartingForm>GE_FORM_1</StartingForm> <DataSlots>
    <DataSlot>
      <Name>EMPLOYEE_FIRST_NAME</Name>
      <Value></Value>
    </DataSlot> <DataSlot> <Name>EMPLOYEE
      <Value></Value>
    </DataSlot>
    <DataSlot>
      <Name>EMPLOYEE_ID</Name>
      <Value></Value>
    </DataSlot>
    <DataSlot>
      <Name>EMPLOYEE_PHONE</Name>
      <Value></Value>
    </DataSlot> </DataSlots> </FormSet>
```

The Assets Control File

```
<Assets>
  <Asset> <Name>ASSET_1</Name> <Type>Image</Type>
    <Entry>MyPhoto.jpg</Entry>
  </Asset>
  <Asset> <Name>ASSET_2</Name> <Type>Image</Type>
    <Entry>YourPhoto.jpg</Entry>
  </Asset>
  <Asset>
    <Name>ASSET_{—} 3</Name> <Type>Movie</Type>
    <Entry>FamilyPicnic.mp4</Entry>
  </Asset>
  <Asset>
    <Name>ASSET_4</Name> <Type>DataSet</Type>
    <Entry>MemberList.csv</Entry>
  </Asset>
</Assets>
```

The Form

```
<Form>
  <Name>GE_FORM_1</Name>
  <Components>
    <Component>
      <Name>LABEL_1</Name>
      <Type>Label</Type>
      <XCoord>10</XCoord>
      <YCoord>5</YCoord>
      <Width>55</Width>
      <Height>15</Height>
      <Visible>True</Visible>
      <Value>Please Enter your First Name</Value>
    </Component>
    <Component>
      <Name>LABEL_2</Name>
      <Type>Label</Type>
      <XCoord>10</XCoord>
      <YCoord>10</YCoord>
      <Width>55</Width>
      <Height>15</Height>
      <Visible>True</Visible>
      <Value>Please Enter your Last Name</Value>
    </Component>
    <Component>
      <Name>EDIT_1</Name>
      <Type>SingleLineEdit</Type>
      <XCoord>58</XCoord>
      <YCoord>5</YCoord>
      <Width>55</Width>
      <Height>15</Height>
      <Visible>True</Visible>
      <Value></Value>
    </Component>
    <Component>
      <Name>EDIT_2</Name>
      <Type>SingleLineEdit</Type>
      <XCoord>58</XCoord>
      <YCoord>10</YCoord>
      <Width>55</Width>
      <Height>15</Height>
      <Visible>True</Visible>
      <Value></Value>
    </Component>
    <Component>
      <Name>BUTTON_1</Name>
      <Type>StandardButton</Type>
      <XCoord>60</XCoord>
      <YCoord>30</YCoord>
      <Width>30</Width>
      <Height>15</Height>
      <Visible>True</Visible>
      <Value>Next</Value>
      <Triggers>
        <Trigger>
          <Name>Clicked</Name>
          <Actions>
            <Action>
              <ComponentName>GENERAL_EXAMPLE
              </ComponentName>
              <ActionName>SetDataSlot</ActionName>
              <DestDataSlot>EMPLOYEE_FIRST_NAME
              </DestDataSlot>
              <SourceData>EDIT_1</SourceData>
              <SourceDataType>Component</SourceDataType>
            </Action>
            <Action>
              <ComponentName>GENERAL_EXAMPLE
              </ComponentName>
              <ActionName>LoadForm</ActionName>
              <FormName>MY_SECOND_FORM</FormName>
            </Action>
          </Actions>
        </Trigger>
      </Triggers>
    </Component>
  </Components>
</Form>
```

The FormSet Package file is a consolidated (i.e., zipped) file containing data that allows the FormSet to be reproduced on the interface 22. In addition, the FormSet Package file contains data that allows the client to edit the FormSet using the application 100. The FormSet Package file is initially created when the client chooses to create a new FormSet from within the application. The FormSet file prefix reflects the name chosen when the FormSet is created. FormSet file extensions can be “.atf”. In the context of the application 100, FormSet files may be stored anywhere on the client's file system. When staged on the interface 22, the file may be located in a FormSets subdirectory.

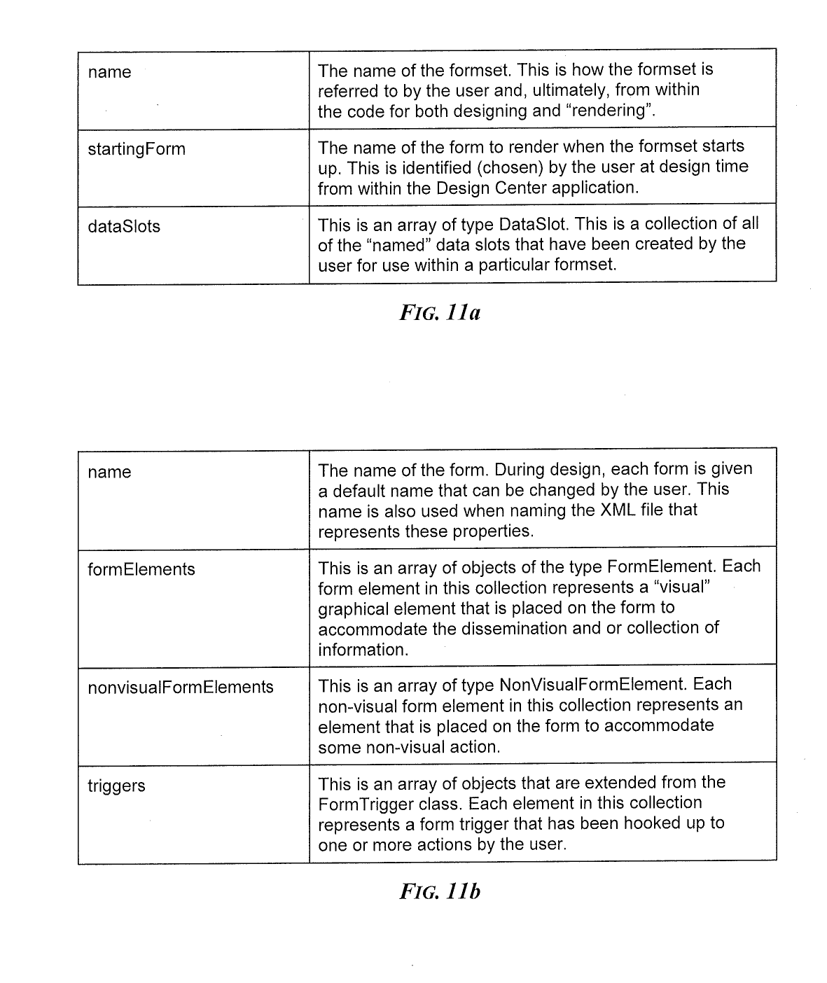

An example of FormSet file structure is shown in FIG. 10. The FormSet Control file may be the main file within the package, and contains XML that defines the basics of the FormSet. The Assets Control file may be an XML file containing information about each Asset within the FormSet file. The Asset files represent resources that are added to the FormSet using an Asset Library within the application 100. Asset files may include mainly static media, such as image, audio, movie files and data files (e.g., CSV files). Allowed file types are supported through code, that is, support for a specific file type (e.g., *.JPG) requires specific code in both sides of the system to understand and utilize its contents.

Pseudo Classes represent an intermediate access layer of classes/objects having data (i.e., properties) shared between the application 100 and the interface 22, but where the implementation is separate and independent. The properties of a Pseudo Class are represented within the XML files transferred from the application 100 and interface 22. Simplified Pseudo Classes, used in conjunction with “real” implementation-specific functions, accommodate simplicity in the serialization and deserialization to and from XML. For convenience concerning serialization, transfer, and marshaling, Properties can be defined as one of the following: string; simple object (simple class), and; array (of string or simple object).

The tables shown in FIGS. 15a-f include exemplary Pseudo Class summary descriptions. The list of classes themselves and Properties is not intended to be extensive nor complete, and includes only the base classes. The table shown in FIG. 15a contains Properties relative to the organization, contents and design of a FormSet, for example. The table shown in FIG. 15b contains Properties relative to the design, rendering and execution of a single form within the FormSet, for example. The table shown in FIG. 15c contains the Properties relative to the placement, rendering and use of a single visual form element, for example Examples of form elements can include a text box, label, command button, and graphic image, among others more complex elements. The table shown in FIG. 15d contains Properties relative to the use and execution of a single non-visual form element, for example. A non-visual form element represents the encapsulation of specific functionality that does not have a direct visual context. Examples of non-visual form elements include Web-Service Components, Barcode Scanner Components and Simple Timer Components, among others. The table shown in FIG. 15e contains Properties of the Triggers, for example. While the base classes used for deriving the various Trigger classes are specific to the type of implementation (i.e., form, form element and non-visual form element), the Triggers can ultimately be inherited from a single Trigger class. The table shown in FIG. 15f contains Properties of the Action base class, for example. While the base classes used for deriving the various Action classes are specific to the type of implementation (i.e., form, form element and non-visual form element), the Actions can ultimately be inherited from a single Action class. The Properties of the final Action classes can vary depending on implementation.

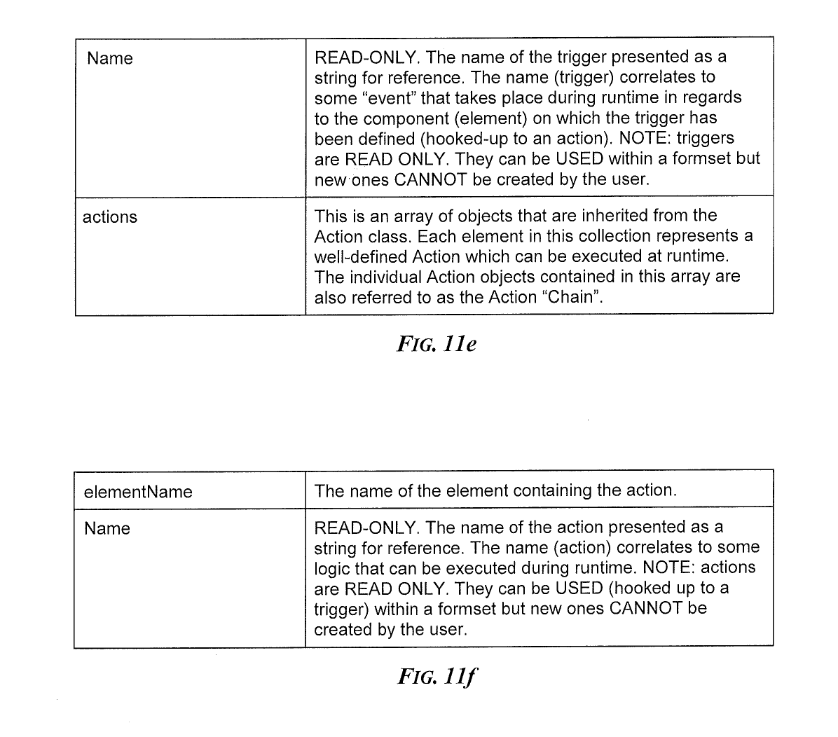

For both design and rendering, the application 100 allows access to a pre-defined set of configuration data within the interface 22. The collection of data is accessed and modified through other means, including the initial setup of the interface 22. The Form Component, as described above, may have an associated Action named such as GetConfigValue. The Action may take the configuration tag name as a parameter and return a DataSlot Value. Access to the low-level configuration data allows the client to use installation-specific settings within the flow of a FormSet. For example, the client can execute a specific sequence of Forms if the display interfaces name matches a given value. The table in FIG. 12 lists pre-defined examples of configuration settings.

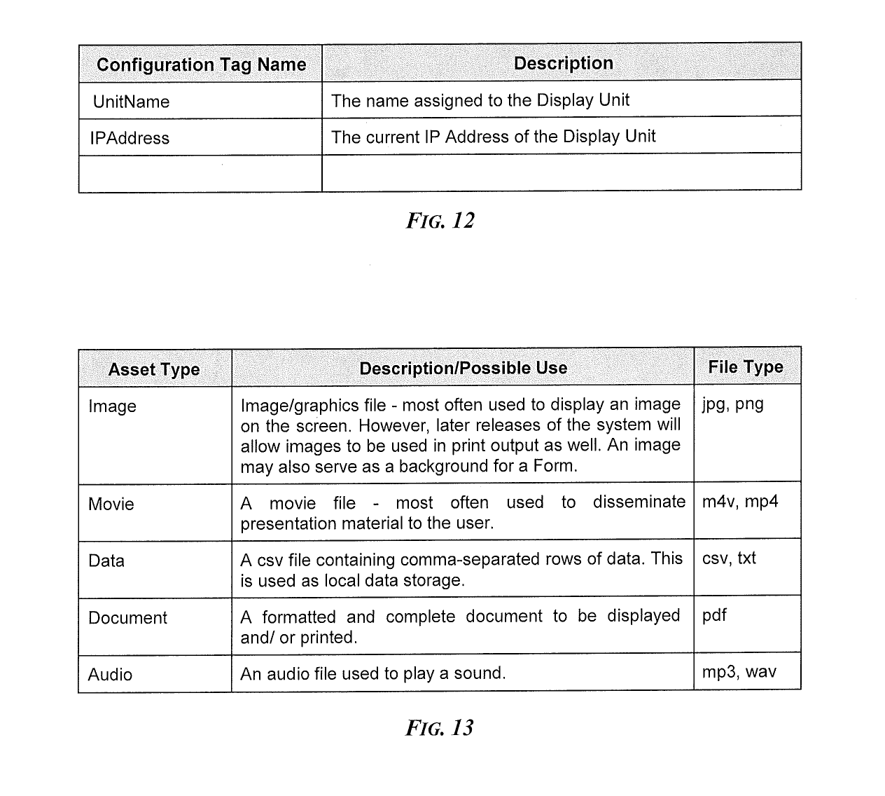

Assets (e.g., images, logos, preconfigured assets, added assets) are localized resources added to the FormSet via the Asset Library within the application 100. Assets represent various types of locally-stored data that can be accessed and used within the rendering and execution of the FormSet. The underlying Assets file (e.g., a jpeg file) can be added to the FormSet file (package file), and appropriate references are made to the file so that it can be accessed and used accordingly. To that extent, Assets travel with the FormSet. The table in FIG. 13 lists examples of supported Asset file types.

Assets are integrated and used within the FormSet by setting the appropriate property of certain Components to the name of the Asset. For example, an Image Component may have a Property named “Image”, and the Property is set to the name of the Asset that contains an image. It should be understood that Components are not restricted to using local Assets. The Image Component, for example, can have an option to set the image to a URL.

The application 100 executes on the interface 22 and renders the forms, collects data and executes the instructions as designed by the client. In addition to general housekeeping, on startup, the application reads a configuration parameter that identifies the FormSet to load (i.e., the default FormSet). The application loads the FormSet and the initial form. The application then begins a loop (i.e., infinite loop) wherein the next Action(s) is dictated through Triggers and associated Actions.

The startup process, in general, may be as follows:
1. Application initialization (normal application startup process)
2. Create Global Data Slots (empty array)
3. Create Global Config Info Store (array of global configuration information)
4. Load Default FormSet

When loading the FormSet, the application 100 loads the package file and gains access to its contents. The application then reads the FormSet.xml file in the root of the package file to determine the first form (i.e., the initial form) to load.

The process of loading a FormSet, in general, may be as follows:
1. Locate Default FormSet file (from config. info)
2. Load the file (using a ZIP library or similar methodology)
3. Deserialize the FormSet control file (FormSet.xml file)
4. Locate the initial form file within the FormSet file
5. Deserialize the Form file

Each form, when loaded, is initialized. That is, the individual form elements are instantiated and various structures are setup in order to accommodate the Triggers-to-Actions sequences.

The process of initializing a form is as follows:
1. Iterate through all of the components where an Asset file is used
2. Instantiate those Components (reading the appropriate Asset files)
3. Iterate through all of the Non-Visual Form elements and instantiate (but do not start) each of those
4. Iterate through all of the Visual Form elements and instantiate (but do not start) each of those
5. Instantiate objects/classes representing the required Actions
6. Map “events” to appropriate Triggers where required and point those to the Actions
7. Start the threads around the Components that were instantiated

Flow after the startup process as described above is determined by the design of the FormSet and the presence or absence of defined Triggers. In general, the application 100 executes the instantiated Actions in accordance with the defined Triggers within the form.

Although the foregoing description provides embodiments of the invention by way of example, it is envisioned that other embodiments may perform similar functions and/or achieve similar results. Any and all such equivalent embodiments and examples are within the scope of the present invention.

1. A kiosk system, comprising:
an interface;
at least one peripheral device; and
a processor communicatively coupled to the interface and the at least one peripheral device, the processor configured to:
create interactive content;
publish the interactive content to the interface; and
execute the interactive content published to the interface.

2. The system of claim 1, wherein the at least one peripheral device comprises a touch responsive display, an information reader, an information writer, a dispenser, a camera, a biometric device, a keypad, a sensor, a light, an audio input/output device, and a communications device.

3. The system of claim 1, wherein the interface is a touch-responsive display.

4. The system of claim 1, wherein the interface comprises non-volatile data storage, an embedded operating system, and the processing unit.

5. The system of claim 1, wherein the interface is a unitary, ethernet-based, input/output controllable, audio and video streaming device.

6. The system of claim 1, wherein the interface comprises an audio controller configured to support multiple audio streaming protocols, speaker outputs, an external microphone input, and a dedicated telephone handset connection.

7. The system of claim 6, wherein the audio controller comprises a plurality of dedicated outputs, a plurality of dedicated inputs, and form-C relays.

8. The system of claim 1, wherein the interface further comprises at least one of a built-in camera, an RS232 DB9 serial port, an RS422/485 configurable port with 4-wire support, a USB connection, and a VGA connection for a monitor.

9. The system of claim 1, further comprising an enclosure housing the interface and the at least one peripheral device.

10. A non-transitory medium for executing processes associated with a reconfigurable kiosk including at least one peripheral device, which when executed by a processor, causes the processor to perform operations comprising:
creating interactive content;
publishing the interactive content to an interface communicatively coupled to the processor;
executing the interactive content published to the interface; and
communicating with the at least one peripheral device.

11. The non-transitory medium according to claim 10, wherein the interactive content is a packaged file including a collection of forms to be displayed on the interface and containing instructions to be executed by the interface.

12. The non-transitory medium according to claim 11, wherein each form comprises an object representation of encapsulated functionality for performing at least one of a peripheral device-specific function and presenting information visually.

13. The non-transitory medium according to claim 10, wherein triggers instructing the processor to carry out actions are associated with peripheral device functions and are conveyed to the processor along with data from the at least one peripheral device.

14. The non-transitory medium according to claim 13, wherein the processor is configured to carry out actions in response to triggers associated with the peripheral device functions, wherein actions comprise one or more of loading forms, transitioning to other forms, displaying messages, copying values of text fields, and executing a web service call.

15. The non-transitory medium according to claim 11, wherein assets comprising images, logos, preconfigured assets, and added assets are stored in an asset library and are available to be added to the forms.

16. The non-transitory medium according to claim 11, wherein the processor is configured to execute the interactive content on the interface, render the forms, collect data from the interface and the at least one peripheral device, and execute instructions.

17. The non-transitory medium of claim 10, wherein the at least one peripheral device comprises a touch responsive display, an information reader, an information writer, a dispenser, a camera, a biometric device, a keypad, a sensor, a light, an audio input/output device, and a communications device.
